(19) United States
(12) Patent Application Publication
(10) Pub. No.: US 2024/0093399 A1
(43) Pub. Date: Mar. 21, 2024

(54) METHOD FOR ELECTROWINNING NEODYMIUM COMPOUND AND MANUFACTURING METHOD FOR NEODYMIUM COMPOUND GRANULES USED THEREOF

(71) Applicant: KSM TECHNOLOGY CO., LTD., Sejong (KR)

(72) Inventors: Hong Youl RYU, Sejong (KR); Hwa Young WOO, Cheongju-si (KR); Vladislav RI, Cheongju-si (KR); Ju Hwan SONG, Cheongju-si (KR); Jeong Mo KIM, Daegu (KR)

(21) Appl. No.: 18/263,109

(22) PCT Filed: Sep. 6, 2022
(86) PCT No.: PCT/KR2022/013361

§ 371 Date: Jul. 26, 2023

(30) Foreign Application Priority Data
Sep. 10, 2021 (KR) 10-2021-0120861

(51) Int. Cl. C25C 3/34; C25C 3/36; C25C 7/02

(52) U.S. Cl. CPC C25C 3/34; C25C 3/36; C25C 7/025

(57) ABSTRACT

Provided is a method for electrowinning neodymium compound. The method includes providing a fluoride-based electrolyte through an opening defined in an electrolytic bath including a cathode and an anode. The method includes providing granules, each including a neodymium compound and having at least one cavity defined therein, through the opening defined in the electrolytic bath. The method includes dissolving at least a portion of the granule in a molten salt of the fluoride-based electrolyte. The method also includes reducing neodymium at the cathode. The cavity is defined inside or on the surface of the granule, and the apparent density of the granules is lower than the density of the molten salt. The method proposed has an improved process compared to those of the related art.

### BACKGROUND

### Technical Field

The present disclosure relates to a method for electrowinning of a neodymium compound and a method for producing neodymium compound granules for use therein, and more specifically, to a method for producing neodymium compound granules, each having at least one cavity defined therein, and a method of reducing a neodymium compound in an environmentally friendly, inexpensive, and high efficiency using neodymium compound granules produced thereby.

### Description of the Related Art

Permanent magnets have been applied in various fields, and various studies have been conducted to improve the performance of permanent magnets. In particular, from the viewpoint of energy saving or environmental friendliness, studies on permanent magnets have been actively conducted in fields such as IT, automobiles, and home appliances.

The most widely used neodymium magnet among permanent magnets is a permanent magnet based on a neodymium-iron-boron (Nd—Fe—B)-based intermetallic compound (Nd₂Fe₁₄B). Since neodymium magnets have advantages such as excellent magnetic properties, high strength, and low production cost, they have been used in various industrial products and their production volume has increased exponentially. The main applications of neodymium (Nd) magnets include hard disk voice coil motors, air conditioner compressor motors, motors for hybrid vehicles, and the like.

Meanwhile, for neodymium (Nd) which is a raw material for neodymium magnets, mineral deposits with excellent mining potential are concentrated in a specific country. Due to the export regulations of the corresponding country, etc., the price of neodymium is likely to fluctuate and the stable supply of neodymium is becoming difficult. Therefore, an efficient process for smelting neodymium for use in the manufacture of permanent magnets and the like is further required.

Meanwhile, a thermal reduction method has also been used for smelting of neodymium, but this method is not suitable for industrial mass production because continuous smelting is not possible.

Regarding a method for electrowinning of neodymium, a method of electrowinning neodymium by reducing neodymium oxide using neodymium oxide powder is conventionally known.

### PATENT DOCUMENTS

Japanese Patent Application Publication No. 2020-158730
Korean Patent Application Publication No. 10-2007-0001137

### BRIEF SUMMARY

When neodymium oxide powder in the conventional art is used, the raw material is scattered during the process, causing problems in the process. In addition, since the neodymium oxide powder precipitates and agglomerates in the electrolytic bath, difficulties arise in the recovery of reduced neodymium. In addition, when process conditions are not maintained during the oxidation of neodymium oxide using a fluoride-based electrolyte, small amounts of fluorine-containing compounds such as CF4 gas, which is a greenhouse gas, are generated, which greatly affect the greenhouse effect. Furthermore, a conventional process has problems in that the electrolyte easily evaporates at the exposed electrolyte surface and the exposed electrode is likely to be oxidized by reaction with oxygen in the air.

Based on the various technical problems in the conventional art including the above-identified problem by the inventors, various embodiments of the present disclosure provide a method of reducing neodymium oxide that is environmentally friendly, inexpensive, and highly efficient. That is, the present disclosure provide an environmentally friendly, inexpensive, and highly efficient method of reducing a neodymium compound using granules, each including the neodymium compound and having at least one cavity defined therein.

Various embodiments of the present disclosure provide a method for reducing a neodymium compound, which may increase the high-quality production rate of a final product compared to the conventional technology and is advantageous for commercialization due to its high energy efficiency.

Various embodiments of the present disclosure provide a method for producing neodymium compound granules suitable for use in the above-described excellent method for reducing a neodymium compound.

According to one example embodiment of the present disclosure, there is provided a method for electrowinning neodymium compound, the method including: providing a fluoride-based electrolyte through an opening defined in an electrolytic bath including a cathode and an anode; providing granules, each including a neodymium compound and having at least one cavity defined therein, through the opening defined in the electrolytic bath; dissolving at least a portion of the granules in a molten salt of the fluoride-based electrolyte; and reducing neodymium at the cathode, wherein the cavity defined inside or on the surface of the granule, and the apparent density of the granules is lower than the density of the molten salt.

According to another example embodiment of the present disclosure, there is provided a method for producing neodymium compound granules for use in electrowinning, the method including: forming a granule precursor by adding a binder to neodymium compound powder or adding the binder to a mixture of neodymium compound powder and graphite powder; drying the granule precursor; and heat-treating and sintering the dried granule precursor by heating at a temperature of 800° C. to 1,500° C.

### BRIEF DESCRIPTION OF THE SEVERAL VIEWS OF THE DRAWINGS

FIG. 1 is a schematic sectional view of an electrolytic bath in which an electrowinning process is in progress;

FIG. 2 shows neodymium compound granules, specifically neodymium oxide granules;

FIG. 3 shows the operation of mixing Nd₂O₃ powder and graphite powder (a to c), and a granule forming operation and granule spheronization operation (d);

FIG. 4 shows neodymium oxide granules of Example 1;

FIG. 5 shows neodymium oxide granules of Example 2;

FIG. 6A is a view showing a piece of the granule of Example 1;

FIG. 6B is an enlarged view showing the granule of Example 1 at 1,000× magnification; and

FIG. 6C is an enlarged view showing the granule of Example 1 at 5,000× magnification.

### DETAILED DESCRIPTION

Hereinafter, the intentions, actions and effects of the present disclosure will be described in detail through specific descriptions and examples to assist in understanding the example embodiments of the present disclosure and to implement these example embodiments. However, the following descriptions and example embodiments are presented as examples to assist in understanding the present disclosure as described above, and the scope of the disclosure is neither defined thereby nor limited thereto.

Prior to describing the present disclosure in detail, it should be noted that the terms or words used in the present specification and claims should not be construed as being limited to typical meanings or dictionary definitions, but should be interpreted as having meanings and concepts relevant to the technical scope of the present disclosure, based on the principle according to which an inventor may appropriately define the meanings of the terms in order to describe his or her disclosure in the best way.

Accordingly, it should be understood that the example embodiments described in the present specification and the configurations shown in the drawings are merely the most preferred example embodiments, but do not cover all the technical spirits of the present disclosure, so that there may be various equivalents and modifications capable of replacing them at the time of filing the present disclosure.

In the present specification, singular expressions include plural expressions unless the context clearly indicates otherwise. In the present specification, it should be understood that terms such as “include” and “have” are intended to denote the presence of mentioned characteristics, numbers, operations, components, or combinations thereof, but do not exclude the possibility of presence or addition of one or more other characteristics, numbers, operations, components, or combinations thereof.

The term “and/or” as used herein refers to and encompasses any and all possible combinations of one or more of the associated listed items.

As used herein, the term “same” is a term including cases in which there are only ordinary slight differences that may occur for various reasons such as processes in the art.

Hereinafter, the present disclosure will be described in detail in the order of a method for producing granules for use in a method for electrowinning of a neodymium compound, a method for electrowinning of a neodymium compound, and examples.

1. Method for Electrowinning of Neodymium Compound

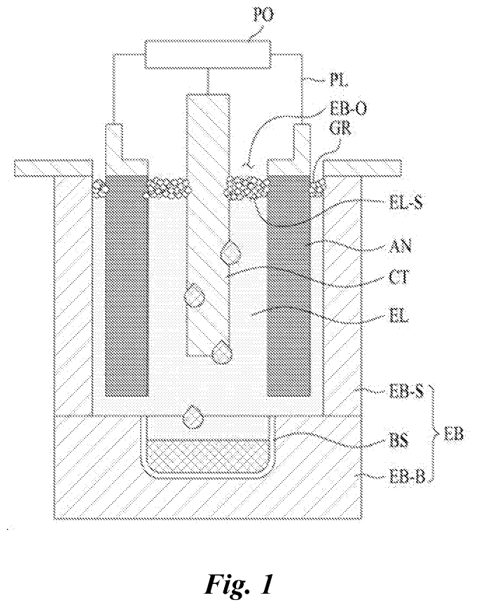

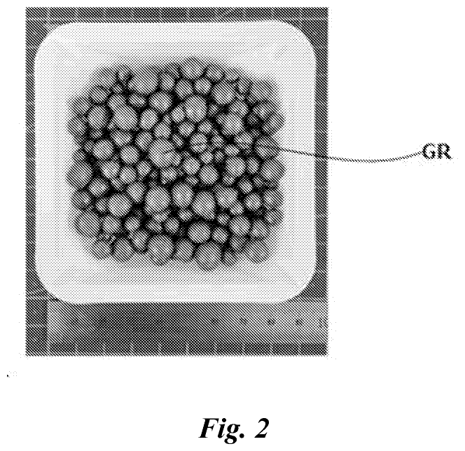

Hereinafter, a method of obtaining reduced pure neodymium (ND) metal by electrowinning a neodymium compound according to the present disclosure will be described in detail with reference to FIGS. 1 and 2. In this specification, although the electrowinning method will be described based on individual operations, this does not specify the order of the operations. It is to be understood that the individual operations of the method of the present disclosure may not proceed in the order described herein unless contradictory, and the operations may proceed concurrently. FIG. 1 is a schematic sectional view of an electrolytic bath EB in which an electrowinning process is in progress. FIG. 2 shows neodymium compound granules (GR), specifically neodymium oxide granules (GR).

A method for electrowinning neodymium compound according to the present disclosure may include the operations of:

providing a fluoride-based electrolyte (EL) through an opening (EB-O) defined in an electrolytic bath including a cathode (CT) and an anode (AN); providing granules (GR), each including a neodymium compound and having at least one cavity (CV) defined therein, through the opening (EB-O) defined in the electrolytic bath (EB); dissolving at least a portion of the granules (GR) in a molten salt of the fluoride-based electrolyte (EL); and reducing neodymium (ND) at the cathode (CT), wherein the cavity may be defined inside or on the surface of the granule (GR), and the apparent density of the granules (GR) may be lower than the density of the molten salt.

The electrolytic bath (EB) may include a bottom (EB-B) and a side (EB-S). In addition, the opening (EB-O) may be defined in the electrolytic bath (EB). During the process, the electrolyte (EL) and/or the granules (GR) may be provided through the opening (EB-O).

A basket (BS) for accommodating neodymium (ND) reduced by a reaction between the electrolyte (EL) and the cathode (CT) may be provided at the bottom (EB-B) of the electrolytic bath (EB). The basket (BS) may be provided under the cathode (CT) so that it corresponds to the position of the cathode (CT), but the example embodiment is not limited thereto. Although not shown in the drawing, the basket (BS) may include a tapping spout for easily recovering the reduced neodymium (ND). The tapping spout may be opened or closed through a separate device, and the reduced neodymium (ND) in a molten state may be recovered through the tapping spout. However, the example embodiment is not limited thereto, and the reduced neodymium (ND) may be recovered through the opening (EB-O) defined in the electrolytic bath (EB).

In one example embodiment, the fluoride-based electrolyte (EL) may include a mixed salt of an alkali metal or alkaline earth metal fluoride compound and NdF₃. The fluoride-based electrolyte (EL) may be provided in the form of a molten salt of an alkali metal or alkaline earth metal fluoride compound and NdF₃. One, two, or more alkali metal or alkaline earth metal fluoride compounds may be included in the fluoride-based electrolyte (EL). Examples of the alkali metal or alkaline earth metal in the alkali metal or alkaline earth metal fluoride compound include Li, Mg, Na, K and Ca. The alkali metal or alkaline earth metal fluoride compound may be used without particular limitation as long as it is a compound used in the technical field, such as LiF or CaF₂. The fluoride-based electrolyte (EL) may include, for example, a mixed salt of LiF and NdF₃. Due to the high melting point of NdF₃, it is difficult to perform electrowinning of NdF₃ alone. However, by using an alkali fluoride compound such as LiF, it is possible to use a eutectic composition having a low melting point in the process.

The fluoride-based electrolyte (EL) may include, based on the total weight of the electrolyte (EL), 5 to 50 wt. % or 10 to 50 wt. % of LiF and 20 to 95 wt. % or 20 to 80 wt. % of NdF₃. In the electrolyte (EL), LiF and NdF₃ may be included at a weight ratio of about 40:60 to 5:95, or about 40:60 to 20:80, for example, about 30:70.

The cathode (CT) and the anode (AN) may be spaced apart from each other by a predetermined distance. The cathode (CT) and the anode (AN) may be electrically connected to a power supply unit (PO) that supplies power. For example, each of the cathode (CT) and the anode (AN) may be electrically connected to the power supply unit (PO) through a power supply line (PL). When a current is supplied from the power supply unit (PO) to the cathode (CT) and the anode (AN) through the power supply line (PL), the neodymium compound may be reduced to neodymium metal at the cathode (CT) to obtain pure neodymium (ND) metal.

At least a portion of the cathode (CT) and/or the anode (AN) may be immersed in the molten salt. At least a portion of the cathode (CT) and/or the anode (AN), particularly the anode (AN), may be exposed to air. That is, the cathode (CT) and/or the anode (AN) may include a contact portion, immersed in the electrolyte (EL) to contact the electrolyte, and an exposed portion exposed to air.

Referring to FIG. 1, one cathode (CT) and two anodes (AN) are illustrated as being provided in the electrolytic bath (EB), but the example embodiment is not limited thereto. The electrolytic bath (EB) may include 1 to 5, 1 to 4, 1 to 3, or 1 or 2 cathodes (CT) and/or anodes (AN). For example, the electrolytic bath (EB) may include one cathode (CT) and one, two, or four anodes (AN). As shown in FIG. 1, the anode (AN) is shown as being arranged to surround the cathode (CT), but the example embodiment is not limited thereto, and any conventional electrode arrangement known in the technical field may be applied to the present disclosure without limitation.

The above descriptions of the cathode (CT), the anode (AN) and the electrolytic bath (EB) are illustrative. It is obvious that the structures of the cathode (CT), the anode (AN) and the electrolytic bath (EB) may be modified into forms commonly used in the technical field.

Meanwhile, in a conventional technology, powder including neodymium oxide was introduced into the electrolytic bath (EB) and the process proceeds. Thus, the powder including neodymium oxide was scattered into the air, resulting in loss of the raw material and difficulties in the process. In particular, since very high heat was applied to the electrowinning process, the powder was very actively scattered by thermal convection generated by the heat, resulting in loss of the raw material and a great problem in process safety.

Furthermore, a problem arose in that, since the density of the powder including neodymium oxide was higher than the density of the electrolyte (EL), the powder settled on the bottom of the electrolytic bath (EB). The settled neodymium oxide powder is poorly soluble in the electrolyte and does not participate in the reaction. In addition, a periodic stirring process is required to treat the settled neodymium oxide powder. As a result, various process problems occurred, such as an increase in process difficulty and a decrease in yield.

In one example embodiment of the present disclosure, granules (GR) including a neodymium compound are provided in the electrolytic bath. Thus, the granules (GR) may be easily introduced without scattering in the air. In addition, since the density of the granules (GR) is lower than the density of the electrolyte (EL), they can continuously float on the surface (EL-S) of the electrolyte (EL), and thus the granules (GR) do not settle at the bottom of the electrolytic bath (EB).

In addition, the neodymium compound may be continuously supplied to the electrolyte (EL) while the granules (GR) remain on the surface (EL-S) of the electrolyte (EL). Since continuous electrowinning is possible for a long time, the process may speed up, and the cost used in the process may also be reduced.

In one example embodiment, the granules (GR) are continuously dissolved in the electrolyte (EL) as neodymium is reduced, and thus the concentration of the neodymium compound in the electrolyte (EL) may be maintained at a constant level. For example, the concentration of the neodymium compound in the electrolyte (EL) may be maintained at about 0.1 to 5 wt. %, about 0.5 to 3 wt. %, about 1 to 3 wt. %, or about 2 wt. %.

The operation of providing the granules (GR) may include the operation of covering the surface (EL-S) of the electrolyte (EL) and the exposed portion of the anode (AN) with the granules (GR). In this specification, the surface (EL-S) of the electrolyte (EL) is defined as a surface where the electrolyte (EL) comes into contact with air.

The cathode (CT) and the anode (AN) may include materials commonly used in the technical field. For example, the cathode (CT) may include tungsten or molybdenum, and the anode (AN) may include graphite. For example, the cathode (CT) may be a tungsten electrode made of tungsten, and the anode (AN) may be a graphite electrode made of graphite. The cathode (CT) may include, for example, iron (Fe). For example, when the cathode (CT) includes iron, neodymium may be smelted in the form of an iron alloy (NdFe).

As shown in the drawing, one or more (for example, two or more) anodes (AN) may be disposed in the electrolytic bath (EB), but the present disclosure is not limited thereto.

At the cathode (CT), neodymium ion may be reduced to neodymium metal by a reaction according to Reaction Formula 1 below.

Nd³⁺+3e⁻=Nd Reaction Formula 1

At the anode (AN), carbon dioxide gas may be generated by a reaction according to Reaction Formula 2 below. When process conditions are not maintained, gases such as carbon tetrafluoride may be generated by a reaction according to Reaction Formula 3 below.

C+2O⁻²=CO₂+4e⁻ Reaction Formula 2

C+4F⁻=CF₄+4e⁻ Reaction Formula 3

The process temperature of the electrowinning process may be higher than the temperature at which the electrolyte is melted and neodymium compound is reduced. For example, the electrowinning process may be performed by selecting the most reasonable temperature in terms of thermal efficiency from among temperatures of about 800 to 1,300° C., about 800 to 1,100° C., about 800 to 900° C., or about 1,200° C. In this high-temperature process, the cathode (CT) and/or the anode (AN) may be heated to a high temperature. In this case, exposed portions of the cathode (CT) and/or the anode (AN) may be oxidized by contact with air. For example, when the anode (AN) includes graphite, carbon in an exposed portion of the anode (AN) may react with oxygen in the air to form carbon dioxide. In this case, the consumption rate due to oxidation of the anode (AN) may increase, and thus the replacement cycle of the anode (AN) may be very frequent. In addition, when the electrolyte (EL) is heated at high temperature, the molten salt is evaporated and lost, and thus a process of continuously replenishing the electrolyte (EL) is required. Thus, a problem arises in that the process slows down and the process cost is increased.

However, in one example embodiment of the present disclosure, the granules (GR) are provided to cover the surface (EL-S) of the electrolyte (EL) and the exposed portion of the anode (AN), and thus the surface (EL-S) of the electrolyte (EL) and the exposed portion of the anode (AN) are prevented from being exposed to air.

More specifically, in the operation of providing the granules (GR) to the electrolytic bath (EB), the granules (GR) may cover the surface of the molten salt and at least a portion of the exposed portion of the anode (AN), thereby blocking or reducing the contact of the anode (AN) and the molten salt with a gas. For example, the granules (GR) may cover both the surface of the molten salt and the exposed portion of the anode (AN).

Therefore, according to one example embodiment of the present disclosure, oxidation of the anode (AN) by reaction with air may be prevented or reduced, and evaporation of the electrolyte (EL) into the air may also be prevented or reduced. Accordingly, the interval for replacing the anode (AN) or replenishing the electrolyte (EL) may be minimized, and thus continuous electrowinning is possible for a long time and material costs may be reduced. Thus, according to one example embodiment, high process speed and cost reduction may be achieved.

Meanwhile, fluorocarbon gases such as CF₄ or C₂F₆, which are greenhouse gases, may be generated during the electrowinning process of the neodymium compound. CF₄ has a global warming potential about 6,500 times higher than CO₂ and takes about 50,000 years to naturally decompose in the air, and C₂F₆ has a global warming potential about 9,200 times higher than CO₂ and takes about 10,000 years to naturally decompose in the air. Thus, these fluorocarbon gases can cause fatal environmental pollution. Therefore, according to a conventional process, much cost may be incurred to provide facilities for treating fluorocarbon gases. However, according to one example embodiment, the neodymium compound granules (GR) cover at least a portion or all of the electrolyte surface (EL-S), and thus CF₄ gas may contact the neodymium compound granules (GR) while being emitted, and may chemically react according to Reaction Formula 4 below, for example.

2Nd₂O₃+3CF₄=2NdF₃+3CO₂ Reaction Formula 4

Accordingly, equipment costs for treating CF₄ may be reduced, and process costs may be reduced because the greenhouse gas CF₄ may be converted to NdF₃ again.

Referring to FIG. 2, in one example embodiment, the shape of the granule (GR) may be spherical or may be quasi-spherical with curves on the spherical surface. However, the example embodiment is not limited thereto, and the granule (GR) may be defined in various shapes depending on the production process and production method. Referring to FIG. 2, in one example embodiment, the diameter of the granule (GR) may be about 1 mm to 50 mm, about 1 mm to 30 mm, about 1 mm to 15 mm, about 1 mm to 10 mm, about 1 mm to 5 mm, about 1 mm. When the granule (GR) is not spherical, the diameter of the granule (GR) may mean the average length of line segments connecting two points on the circumference of the granule GR to a straight line passing through the center of gravity of the granule (GR).

The above-described diameter of the granule (GR) may mean the diameter of each individual granule (GR) or the average diameter of a plurality of granules (GR). In one example embodiment, the diameters of the plurality of granules (GR) may be substantially the same as or different from each other.

The diameter of the granule (GR) is not limited to the above-mentioned length. However, when the diameter of the granule (GR) is within the above-described range, the volume may be properly maintained while the exposed portion of the anode AN and the surface EL-S of the electrolyte EL are sufficiently blocked from the air.

As used herein, the term “neodymium compound” may be defined as including at least one selected from the group consisting of neodymium oxide, praseodymium-neodymium oxide, neodymium oxalate, praseodymium-neodymium oxalate, neodymium carbonate, and praseodymium-neodymium carbonate.

In one example embodiment, neodymium oxide may include Nd₂O₃, neodymium oxalate may include Nd₂(C₂O₄)₃, and neodymium carbonate may include Nd₂(CO₃)₃. The theoretical decomposition potential of Nd₂O₃ is about 2.4 to 2.6 V, which is lower than the decomposition potential of NdF₃ (about 4.6 to 5.6 V). Thus, it is possible to selectively smelt Nd₂O₃ in the electrolyte (EL) by applying a current within the decomposition potential range of Nd₂O₃.

In one example embodiment, praseodymium-neodymium oxide, praseodymium-neodymium oxalate and praseodymium-neodymium carbonate may be those in which Nd₂O₃ may be in physically mixed or chemically combined forms of Pr₆O₁₁, Nd₂(C₂O₄)₃ and Pr₂(C₂O₄)₃, Nd₂(CO₃)₃ and Pr₂(CO₃)₃, respectively.

In one example embodiment, in the praseodymium-neodymium oxide (Nd₂O₃+Pr₆O₁₁) in which Nd₂O₃ and Pr₆O₁₁ are chemically combined with each other, Nd₂O₃ may be included in an amount of more than 70 wt. % (Nd₂O₃>70%), more than 75 wt. %, more than 80 wt. %, more than 85 wt. %, more than 90 wt. %, or more than 95 wt. %, based on the total weight of the praseodymium-neodymium oxide, and Pr₆O₁₁ may be included in an amount of less than 30 wt. %, less than 25 wt. %, less than 20 wt. %, less than 15 wt. %, less than 10 wt. %, or less than 5 wt. %, based on the total weight of the praseodymium-neodymium oxide. The molar ratio of praseodymium relative to the total number of moles of praseodymium and neodymium elements in the praseodymium-neodymium oxide may be about 30% or less, 25% or less, about 20% or less, about 15% or less, about 10% or less, or about 5% or less.

In one example embodiment, in the praseodymium-neodymium oxalate (Nd₂(C₂O₄)₃+Pr₂(C₂O₄)₃) in which Nd₂(C₂O₄)₃ and Pr₂(C₂O₄)₃ are chemically combined with each other, Nd₂(C₂O₄)₃ may be included in an amount of more than 70 wt. % (Nd₂(C₂O₄)₃>70%), more than 75 wt. %, more than 80 wt. %, more than 85 wt. %, more than 90 wt. %, or more than 95 wt. %, based on the total weight of the praseodymium-neodymium oxalate, and Pr₂(C₂O₄)₃ may be included in an amount of less than 30 wt. %, less than 25 wt. %, less than 20 wt. %, less than 15 wt. %, less than 10 wt. %, or less than 5 wt. %, based on the total weight of the praseodymium-neodymium oxalate. The molar ratio of praseodymium relative to the total number of moles of praseodymium and neodymium elements in the praseodymium-neodymium oxalate may be about 30% or less, 25% or less, about 20% or less, about 15% or less, about 10% or less, or about 5% or less.

In one example embodiment, in the praseodymium-neodymium carbonate (Nd₂(CO₃)₃+Pr₂(CO₃)₃) in which Nd₂(CO₃)₃ and Pr₂(CO₃)₃ are chemically combined with each other, Nd₂(CO₃)₃ may be included in an amount of more than 70 wt. % (Nd₂(CO₃)₃>70%), more than 75 wt. %, more than 80 wt. %, more than 85 wt. %, more than 90 wt. %, or more than 95 wt. %, based on the total weight of the praseodymium-neodymium carbonate, Pr₂(CO₃)₃ may be included in an amount of less than 30 wt. %, less than 25 wt. %, less than 20 wt. %, less than 15 wt. %, less than 10 wt. %, or less than 5 wt. %, based on the total weight of the praseodymium-neodymium carbonate. The molar ratio of praseodymium relative to the total number of moles of praseodymium and neodymium elements in the praseodymium-neodymium carbonate may be about 30% or less, 25% or less, about 20% or less, about 15% or less, about 10% or less, or about 5% or less.

In one example embodiment, any one or more selected from the group consisting of neodymium oxide, neodymium oxalate and neodymium carbonate may be smelted together with any one or more selected from the group consisting of praseodymium-neodymium oxide, praseodymium-neodymium oxalate and praseodymium-neodymium carbonate, in the form of a praseodymium-neodymium alloy to one example embodiment of the present disclosure. Since praseodymium has properties similar to those of neodymium, a permanent magnet may be manufactured from a praseodymium-neodymium alloy smelted according to one example embodiment. For example, when the molar ratio of praseodymium is about 30% or less, 25% or less, about 20% or less, about 15% or less, about 10% or less, or about 5% or less, it is possible to manufacture a permanent magnet exhibiting excellent effects.

In one example embodiment, the cavity (CV) may be defined inside the granule (GR) or on the surface of the granule (GR). When the cavity (CV) is defined on the surface of the granule (GR), the cavity (CV) may be hemispherical or quasi-hemispherical in shape.

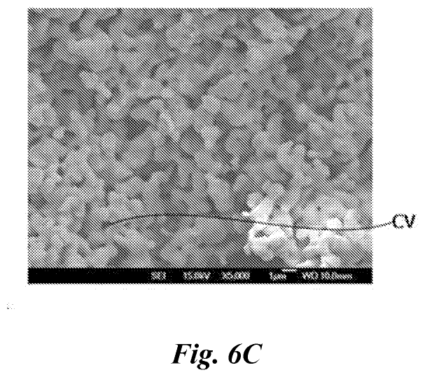

In one example embodiment, the diameter of the cavity (CV) may be 1 μm to 100 The cavity (CV) is shown in more detail in FIGS. 6a to 6c to be described later.

The volume ratio of the cavity (CV) in the neodymium compound granule (GR) may be defined such that the density of the granule (GR) is lower than the density of the electrolyte (EL). For example, the volume ratio of the cavity (CV) defined in the neodymium compound granule (GR) (the volume of the cavity/the volume of the granule; hereinafter referred to as cavity percentage) may be defined as greater than or equal to the value (unit: %) calculated by Equation 1 below.

(1−density of molten salt/density of granules)×100 Equation 1

In one example embodiment, the cavity percentage may be about 15% or more, about 35% or more, about 40% or more, about 45% or more, about 50% or more, or about 37.55% or more. When the cavity percentage is greater than or equal to the value calculated by Equation 1 above, the apparent density of the granules (GR) may be lower than the density of the molten salt.

In this specification, the cavity percentage is calculated based on the volume defined by all the cavities (CV) defined in the granule (GR).

In one example embodiment, the apparent density of the granules (GR) may be 2.0 g/cm³ to 6.0 g/cm³, 2.0 g/cm³ to 5.0 g/cm³, 2.5 g/cm³ to 5.0 g/cm³, 3.0 g/cm³ to 5.0 g/cm³, or 3.0 g/cm³ to 4.5 g/cm³, and the density of the molten salt may be 3.0 g/cm³ to 6.0 g/cm³, 3.0 g/cm³ to 5.0 g/cm³, 3.5 g/cm³ to 5.0 g/cm³, 4.1 g/cm³ to 5.0 g/cm³, 3.5 g/cm³ to 4.5 g/cm³, or 4.1 g/cm³ to 4.5 g/cm³.

For example, when the fluoride-based electrolyte (EL) includes LiF and NdF₃ at a weight ratio of 30:70 and the neodymium oxide is Nd₂O₃, the cavity percentage may be 37.55% or more, and the apparent density of the granules (GR) may be about 4.52 or less.

When the cavity percentage is within the above-described range, the granules (GR) may float well on the molten salt. In addition, the granules (GR) are not easily broken by impact during transportation, and thus storage and transportation convenience may be improved.

2. Method for Producing Neodymium Compound Granules

Hereinafter, a method for producing the above-described neodymium compound granules (GR) will be described in detail. In this specification, although the method for producing neodymium compound granules (GR) will be described based on individual operations, this does not specify the order of the operations. It is to be understood that the individual operations of the method of the present disclosure may not proceed in the order described herein unless contradictory, and the operations may proceed concurrently. In addition, it is to be understood that, unless contradictory, the above description about the neodymium compound granules (GR) used in the above-described method for electrowinning of the neodymium compound may equally applied to the neodymium compound granules (GR) produced by the production method of the present disclosure.

A method for producing neodymium compound granules (GR) for use in electrowinning according to the present disclosure may include the operations of:

forming a granule precursor by adding a binder to neodymium compound powder or adding the binder to a mixture of neodymium compound powder and graphite powder; drying the granule precursor; and heat-treating and sintering the dried granule precursor by heating at a temperature of 800° C. to 1,500° C.

The operation of mixing the neodymium compound powder and the graphite powder may include the operations of: providing the neodymium compound powder and the graphite powder to a mixing device; and rotating the mixing device. The operation of forming the granule precursor may include the operation of adding the binder to the rotating mixing device. The binder allows the neodymium compounds or the neodymium compound and the graphite powder to be well combined with each other so that the granule precursor may be easily formed. The binder may be provided in the form of a binder solution in which the binder is dissolved in an aqueous solvent such as distilled water. For example, the proportion of the binder relative to the total weight of the binder solution may be about 1 wt. % to about 10 wt. %, about 3 wt. % to about 7 wt. %, or about 4 wt. %. Non-limiting examples of the binder include water, methanol, ethanol, propanol, iso-propanol, n-butanol, iso-butanol, tert-butanol, polyvinyl alcohol, polyvinylpyrrolidone, polyacrylic acid, and polymethyl methacrylate. The mixing device may be rotated at about 50 rpm to about 200 rpm, about 50 rpm to about 150 rpm, about 80 rpm to about 120 rpm, for example, about 100 rpm.

The mixing may include spraying a volatile organic compound. Non-limiting examples of the volatile organic compound include, for example, organic compounds having a boiling point of 80° C. or lower. Non-limiting examples of the organic compounds having a boiling point of 80° C. or lower include compounds commonly used in the technical field, for example, alcohols such as methanol or ethanol, n-hexane, and ethyl acetate.

The sintering operation may include the operation of heating the dried granule precursor at a temperature of about 800° C. to about 1,500° C., about 1,100° C. to about 1,400° C., about 1,200° C. to about 1,400° C., about 1,250° C. to about 1,350° C., or about 1,300° C. The heating operation may be performed for about 30 minutes to 90 minutes. For example, the sintering operation may include the operation of heating the dried granule precursor at a temperature of about 800° C. to about 1,500° C., about 1,100° C. to about 1,400° C., about 1,200° C. to about 1,400° C., about 1,250° C. to about 1,350° C., or about 1,300° C. for about 30 minutes to 90 minutes. When the sintering process is performed at a temperature within the above-described temperature range, the sintering degree and density of the produced neodymium compound granules may be suitable for use in the above-described electrowinning process.

The weight ratio between the neodymium compound and the graphite powder that are used to produce the granule precursor may be 60:40 to 90:10, 70:30 to 80:20, or 75:25 to 85:15. The binder may be added in an amount of about 0.5 wt. % to about 3 wt. %, about 1 wt. % to about 2 wt. %, or about 1.5 wt. %, based on the total weight of the neodymium compound and the graphite powder.

In one example embodiment, neodymium oxide may be Nd₂O₃, neodymium oxalate may be Nd₂(C₂O₄)₃, and neodymium carbonate may be Nd₂(CO₃)₃. In one example embodiment, neodymium oxide may be praseodymium-neodymium oxide.

In one embodiment, the neodymium compound granule (GR) may have at least one cavity defined therein. During the production of the neodymium compound granules (GR), the cavity (CV) may be defined while graphite is burned or the binder evaporates, and the cavity (CV) may be defined while the neodymium compound is sintered.

In one example embodiment, the apparent density of the granules (GR) may be 2.0 g/cm³ to 6.0 g/cm³, 3.0 g/cm³ to 5.0 g/cm³, or 3.0 g/cm³ to 4.5 g/cm³, and the density of the molten salt may be 3.0 g/cm³ to 6.0 g/cm³, 3.0 g/cm³ to 5.0 g/cm³, 3.5 g/cm³ to 5.0 g/cm³, 4.1 g/cm³ to 5.0 g/cm³, 3.5 g/cm³ to 4.5 g/cm³, or 4.1 g/cm³ to 4.5 g/cm³. In one example embodiment, the cavity percentage may be about 15% or more, about 35% or more, about 40% or more, about 45% or more, about 50% or more, or about 37.55% or more.

The neodymium compound granules (GR) produced by the production method of one example embodiment may be used in the above-described process of electrowinning neodymium. In one embodiment, the produced neodymium compound granule (GR) may be crushed into two or more pieces and used in the process of electrowinning neodymium. In this specification, the term “neodymium compound granule (GR)” is defined as including crushed products of the neodymium compound granule (GR).

3. Examples

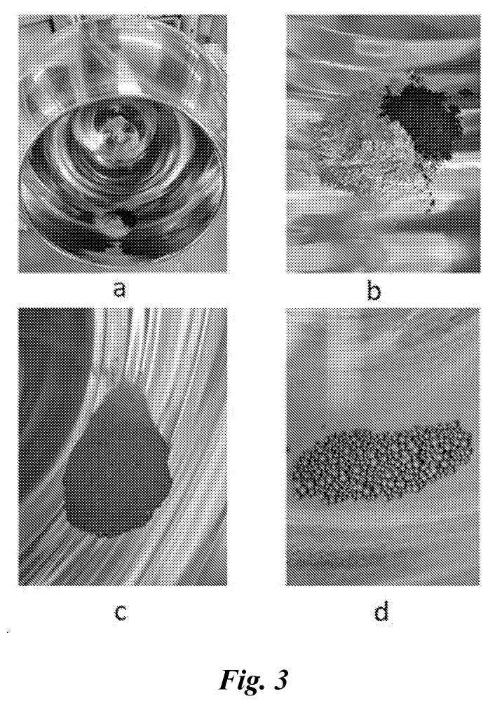

Hereinafter, example will be described in detail with reference to FIGS. 3 to 5 and 6a to 6c, through which the actions and effects of the present disclosure will be demonstrated. However, the following examples are only presented as examples of the present disclosure, and the scope of the present disclosure is not defined thereby.

### EXAMPLES OF NEODYMIUM COMPOUND GRANULES (GR)

### (1) Preparation Example 1: Production of Granules of Example 1

78.5 g of Nd₂O₃ powder, 20.0 g of graphite powder, and 37.5 g of about 4 wt. % polyvinyl alcohol (PVA) solution were prepared. The prepared Nd₂O₃ powder and graphite powder were placed in a raw material granulator, i.e., a mixing device, which was then rotated at a rotational speed of 100 rpm for about 30 minutes. Then, the PVA solution was added in portions thereto to form granules, and about 10 ml of ethanol was sprayed to make the granules spherical. Then, the granules were dried in a fan heater at 50° C. and then recovered.

Subsequently, the produced dried granules were heated at about 1,300° C. for 1 hour to burn (oxidize) or evaporate graphite and PVA and sinter Nd₂O₃, thereby producing granules of Example 1.

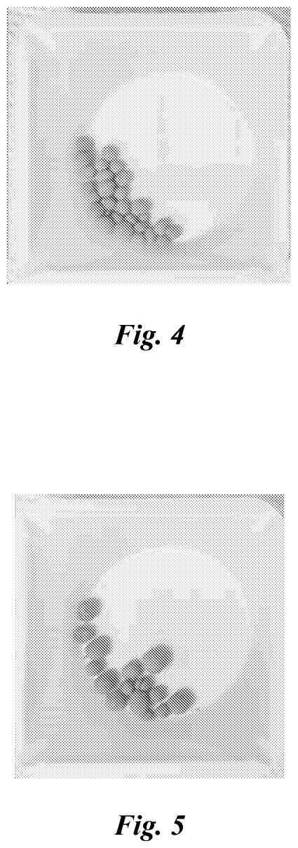

FIGS. 3 and 4 show views based on individual process operations. FIG. 3 shows the operation of mixing Nd₂O₃ powder and graphite powder (a to c), and a granule forming operation and granule spheronization operation (d). FIG. 4 shows neodymium oxide granules (GR) of Example 1 produced by heating the dried granules.

### (2) Preparation Example 2: Production of Granules of Example 2

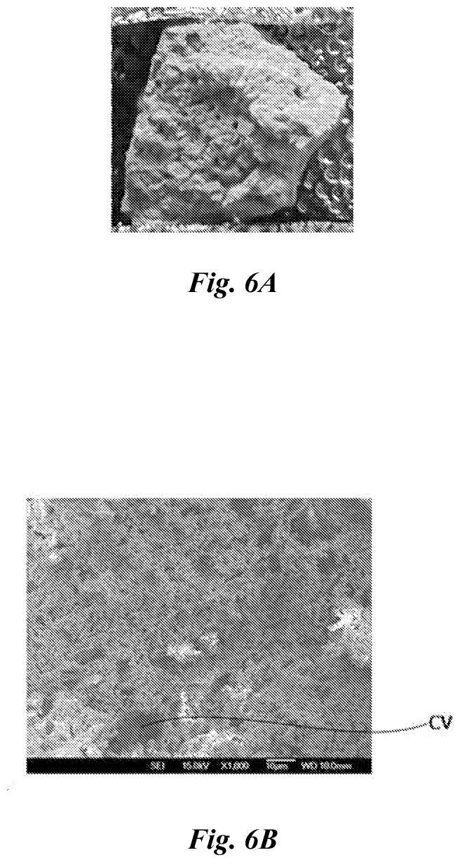

Granules of Example 2 were produced in the same manner as in Preparation Example 1, except that 83.5 g of Nd₂O₃ powder, 15.0 g of graphite powder and 37.5 g of about 4 wt. % polyvinyl alcohol (PVA) solution were used. The produced granules of Example 2 are shown in FIG. 5. FIG. 5 shows the neodymium oxide granules (GR) of Example 2 produced by heating the dried granules.

### (3) Evaluation of Produced Granules

Hereinafter, the results of evaluating the produced granules (GR) will be described in detail with reference to FIGS. 6A to 6C. FIG. 6A is a view showing a piece of the granule of Example 1. FIG. 6B is an enlarged view showing the granule of Example 1 at 1,000× magnification. FIG. 6C is an enlarged view showing the granule of Example 1 at 5,000× magnification. Referring to FIG. 6B, the cavity (CV) defined as the graphite particle was burned is found. Referring to FIG. 6C, the cavity (CV) defined as neodymium oxide was sintered is found. Referring to FIGS. 6A to 6C, it is confirmed that the cavity (CV) is defined in the granule by burning of the graphite particles and sintering of the neodymium oxide, so that the density of the granules (GR) can be lower than that of the electrolyte (EL). In addition, it is confirmed that the strength of the granules (GR) is enhanced by sintering, so that the granules are not easily broken and thus have excellent transportability.

The degree of sintering and density of the granules (GR) of Example 1, and the diameter of the defined cavity (CV) were evaluated in more detail, and the results are shown in Table 1 below.

TABLE 1

| | | Cavity diameter | Density |
|---|---|---|---|
| | Degree of sintering | (μm) | (g/cm³) |
| Example 1 | excellent | 1 to 50 | about 3.93 |

Referring to Table 1 above and FIGS. 6A to 6C, it is confirmed that the sintering proceeded well to the inside of the produced granules (GR), and thus the Nd₂O₃ particles are well connected together and have high strength to the extent that they are not easily broken by external impact. In addition, it is confirmed that the density of the granules (GR) is also very suitable for the process of electrowinning a neodymium compound using a fluoride-based electrolyte. Therefore, the neodymium compound-containing granules (GR) produced according to one example embodiment are very suitable for use in the process of electrowinning neodymium.

Method for Electrowinning of Neodymium Compound

A raw material contained in a ton bag was introduced into each storage hopper using a hoist. The NdF₃+LiF raw material (electrolyte) mixed in the storage hopper was introduced into an electrowinning bath using a shuttle car and a screw conveyor, which are transport devices. While the electrolyte was melted using a graphite electrode connected to an AC power supply to generate a molten salt, the electrolyte was additionally introduced and melted to an appropriate height. A graphite anode and a tungsten cathode were connected to a DC power supply, and Nd oxide was introduced into the electrowinning bath while applying a current. Nd metal generated in a tungsten crucible at the bottom of the electrowinning bath was scooped out using a titanium ladle or recovered through a tapping spout at the bottom. The recovered metal was solidified using a chain conveyor and an argon chamber to obtain reduced neodymium.

| | |
|---|---|
| EB: electrolytic bath | CT: cathode |
| AN: anode | EL: electrolyte |
| GR: granules | ND: reduced neodymium |

According to the present disclosure, there is provided a process for electrowinning of neodymium, in which using granules, each containing a neodymium compound and having at least one cavity defined therein, whereby powder is prevented from scattering or precipitating in the electrolytic bath during the process, indicating that the process achieves excellent process efficiency and is suitable for industrial mass production.

In addition, according to the present disclosure, there is provided a process for electrowinning of neodymium, which prevents oxidation of the electrodes provided in the electrolytic bath, prevents vaporization of the electrolyte, and reduces emission of greenhouse gases, indicating that the process achieves excellent process efficiency, is suitable for industrial mass production, and is environmentally friendly.

In addition, according to the present disclosure, there is provided a process for producing neodymium oxide granules, which is suitable for use in a process for electrowinning of neodymium which achieves excellent process efficiency and is suitable for industrial mass production.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for electrowinning neodymium compound, the method comprising:
providing a fluoride-based electrolyte through an opening defined in an electrolytic bath including a cathode and an anode;
providing granules, each comprising a neodymium compound and having at least one cavity defined therein, through the opening defined in the electrolytic bath;
dissolving at least a portion of the granule in a molten salt of the fluoride-based electrolyte; and
reducing neodymium at the cathode,
wherein the cavity is defined inside or on a surface of the granule, and an apparent density of the granules is lower than a density of the molten salt.

2. The method according to claim 1, wherein at least a portion of each of the cathode and the anode is immersed in the molten salt.

3. The method according to claim 2, wherein at least a portion of the anode is exposed to air; and in the providing granules, the granules cover a surface of the molten salt and at least a portion of an exposed portion of the anode to block or reduce contact of the anode and the molten salt with gas.

4. The method according to claim 1, wherein the cathode comprises tungsten, molybdenum or iron, and the anode comprises graphite.

5. The method according to claim 1, wherein the granules have a diameter of 1 mm to 50 mm.

6. The method according to claim 1, wherein the granules have an apparent density of 2.0 g/cm³ to 6.0 g/cm³ and a cavity percentage of 15% or more.

7. The method according to claim 1, wherein the fluoride-based electrolyte comprises LiF and NdF₃.

8. The method according to claim 1, wherein the fluoride-based electrolyte comprises LiF and NdF₃ at a weight ratio of 40:60 to 5:95.

9. The method according to claim 1, wherein the molten salt has a density of 3.0 g/cm³ to 6.0 g/cm³.

10. The method according to claim 1, wherein the neodymium compound comprises at least one selected from the group consisting of neodymium oxide, praseodymium-neodymium oxide, neodymium oxalate, praseodymium-neodymium oxalate, neodymium carbonate, and praseodymium-neodymium carbonate.

11. The method according to claim 10, wherein the praseodymium-neodymium oxide comprises Nd₂O₃+Pr₆O₁₁(Nd₂O₃>70%), the praseodymium-neodymium oxalate comprises Nd₂(C₂O₄)₃+Pr₂(C₂O₄)₃(Nd₂(C₂O₄)₃>70%), and the praseodymium-neodymium carbonate comprises Nd₂(CO₃)₃+Pr₂(CO₃)₃(Nd₂(CO₃)₃>70%).

12. A method for producing neodymium compound granules for use in electrowinning, the method comprising:
forming a granule precursor by adding a binder to neodymium compound powder or adding the binder to a mixture of neodymium compound powder and graphite powder;
drying the granule precursor; and
heat-treating and sintering the dried granule precursor by heating at a temperature of 800° C. to 1,500° C.

13. The method according to claim 12, wherein the neodymium compound comprises at least one selected from the group consisting of neodymium oxide, praseodymium-neodymium oxide, neodymium oxalate, praseodymium-neodymium oxalate, neodymium carbonate, and praseodymium-neodymium carbonate.

14. The method according to claim 13, wherein the praseodymium-neodymium oxide comprises Nd₂O₃+Pr₆O₁₁(Nd₂O₃>70%), the praseodymium-neodymium oxalate comprises Nd₂(C₂O₄)₃+Pr₂(C₂O₄)₃(Nd₂(C₂O₄)₃>70%), and the praseodymium-neodymium carbonate comprises Nd₂(CO₃)₃+Pr₂(CO₃)₃(Nd₂(CO₃)₃>70%).

15. The method according to claim 12, wherein at least one cavity is defined inside or a surface of the neodymium compound granule.

16. The method according to claim 12, wherein the granules have an apparent density of 2.0 g/cm³ to 6.0 g/cm³ and a cavity percentage of 15% or more.
